(19) United States
(12) Patent Application Publication
(10) Pub. No.: US 2015/0079425 A1
(43) Pub. Date: Mar. 19, 2015

(54) BYPASS SWITCH

(71) Applicants: Yosuke Osako, Tokyo (JP); Toshihisa Oka, Tokyo (JP); Atsushi Sawada, Tokyo (JP)

(72) Inventors: Yosuke Osako, Tokyo (JP); Toshihisa Oka, Tokyo (JP); Atsushi Sawada, Tokyo (JP)

(73) Assignee: Mitsubishi Electric Corporation, Chiyoda-ku, Tokyo (JP)

(21) Appl. No.: 14/395,347

(22) PCT Filed: Apr. 23, 2012
(86) PCT No.: PCT/JP2012/060855

§ 371 Date: Nov. 10, 2014

(51) Int. Cl. H01M 10/42

(52) U.S. Cl. CPC H01M 10/4257; H01M 10/4207
USPC 429/7

(57) ABSTRACT

A bypass switch includes a pair of fixed conductors connected in parallel with a battery cell, a movable conductor disposed in a vertical direction with respect to the pair of fixed conductors, and a thermally actuated device. In the thermally actuated device, a single diode that generates heat by being energized, a metal plate, and solder are stacked and sandwiched between a first and second heat-insulating spacers. When the battery cell malfunctions, the diode is energized and generates heat that is transferred to the solder through the metal plate, causing the solder to melt, and thereby the thermally actuated device to be displaced. Displacement of the thermally actuated device causes the movable conductor to be displaced in the vertical direction with respect to the fixed conductors and inserted between the fixed conductors, electrically connecting the fixed conductors and forming a bypass circuit to short-circuit the malfunctioned battery cell.

### TECHNICAL FIELD

The present invention relates to a bypass switch having a function to short-circuit a malfunctioned cell in a storage battery in which a plurality of cells are connected.

### BACKGROUND ART

In a storage battery in which a plurality of cells are connected in series, a failure in which one of the cells becomes a high resistance state or an open circuit state renders the entire storage battery unusable.

As a countermeasure against the failure in which the cell becomes a high resistance state or an open circuit state, providing a bypass switch may be considered.

Preferably, this bypass switch is lightweight and does not dissipate large power when conducting battery current.

For example, a bypass switch of Patent Literature 1 has formed therein a parallel circuit including a thermally actuated device and a switch part constituted by a pair of fixed conductors and a movable conductor.

The movable conductor is disposed in a vertical direction with respect to the pair of fixed conductors, and receives pressure applied by a pressure device.

The thermally actuated device receives through a shaft the pressure applied to the movable conductor.

The switch part and the thermally actuated device in the bypass switch are connected in parallel with a cell.

When the cell fails, heat generation in the thermally actuated device triggers the pressure device to apply pressure, causing the thermally actuated device to be displaced. Displacement of the thermally actuated device causes the movable conductor to be displaced in the vertical direction with respect to the pair of fixed conductors.

Then, the movable conductor and the fixed conductors come into contact, and the fixed conductors are electrically connected by the movable conductor, thereby forming a bypass path that bypasses the malfunctioned cell.

In the thermally actuated device of Patent Literature 1, two diodes are disposed in series.

That is, in Patent Literature 1, the diodes are arranged in a redundant configuration, realizing a configuration that prevents short-circuit current from flowing through the cell even if a short-circuit fault occurs in one of the diodes.

### CITATION LIST

### Patent Literature

Patent Literature 1: JP 2006-252804 A (pages 4 to 5, FIG. 1)

### SUMMARY OF INVENTION

### Technical Problem

It is desirable that the bypass switch is actuated even if the cell falls into a semi-failure state, that is, even if the polarity of the cell is reversed in case of over discharge in the cell.

However, in the thermally actuated device of Patent Literature 1 configured with two diodes, the voltage drop in the diodes is large. Thus, when the cell is in a semi-failure state, no current flows through the diodes and the bypass switch is not actuated.

Even if current flows through the diodes, the discharge current value is small in case of over discharge and the amount of heat generation in the diodes is small, so that solder may not reach a melting temperature.

Therefore, in case of over discharge in the cell, the over discharge state continues without the bypass switch being actuated. The cell in the semi-failed state is transformed into a resistor and is maintained in a high heat generation state, leading to deterioration in performance of the storage battery.

It is a main object of the present invention to solve the above-described problem, and to provide a bypass switch that promptly performs an operation to close a circuit even in case of over discharge.

### Solution to Problem

A bypass switch according to the present invention includes

a pair of fixed conductors disposed being spaced from each other and connected in parallel with a battery cell;

a movable conductor disposed in a vertical direction with respect to the pair of fixed conductors, and configured to be displaced in the vertical direction with respect to the pair of fixed conductors and inserted between the pair of fixed conductors;

a pressure device configured to apply pressure to the movable conductor in the vertical direction with respect to the pair of fixed conductors;

a thermally actuated device in which a single semiconductor device that generates heat by being energized, a metal plate, and solder are stacked and the semiconductor device, the metal plate, and the solder are sandwiched between a first heat-insulating spacer and a second heat-insulating spacer, the thermally actuated device being configured to be coupled with the movable conductor and receive the pressure applied to the movable conductor; and

a connecting conductor configured to connect the pair of fixed conductors with the semiconductor device, the metal plate, and the solder in parallel,

wherein the semiconductor device is configured not to be energized when the battery cell is in a normal condition, and to be energized and generate heat by being energized when the battery cell malfunctions, and the heat generated in the semiconductor device is transferred to the solder through the metal plate, causing the solder to melt, and melting of the solder causes the thermally actuated device to be displaced by the pressure applied by the pressure device, and displacement of the thermally actuated device causes the movable conductor to be displaced in the vertical direction with respect to the pair of fixed conductors and inserted between the pair of fixed conductors, and the pair of fixed conductors are thereby electrically connected to form a bypass circuit to short-circuit the battery cell that malfunctioned.

### Advantageous Effects of Invention

According to the present invention, a thermally actuated device has a single semiconductor device. Thus, even if a storage battery cell becomes an over discharge state resulting in a semi-failure state, a voltage drop is small and current flows through the semiconductor device, allowing a bypass switch to be actuated.

The semiconductor device, a metal plate, and solder are sandwiched between a first heat-insulating spacer and a second heat-insulating spacer. Thus, even with the single semiconductor device, heat can be effectively transferred to the solder to melt the solder, and the bypass switch is actuated even if the cell becomes a semi-failure state.

### BRIEF DESCRIPTION OF DRAWINGS

FIG. 1 is a schematic cross-sectional view of a bypass switch according to a first embodiment;

FIG. 2 is a circuit diagram in which the bypass switch according to the first embodiment is connected in parallel with a storage battery cell; and

FIG. 3 is a detailed view of a thermally actuated device according to the first embodiment.

### DESCRIPTION OF EMBODIMENTS

First Embodiment

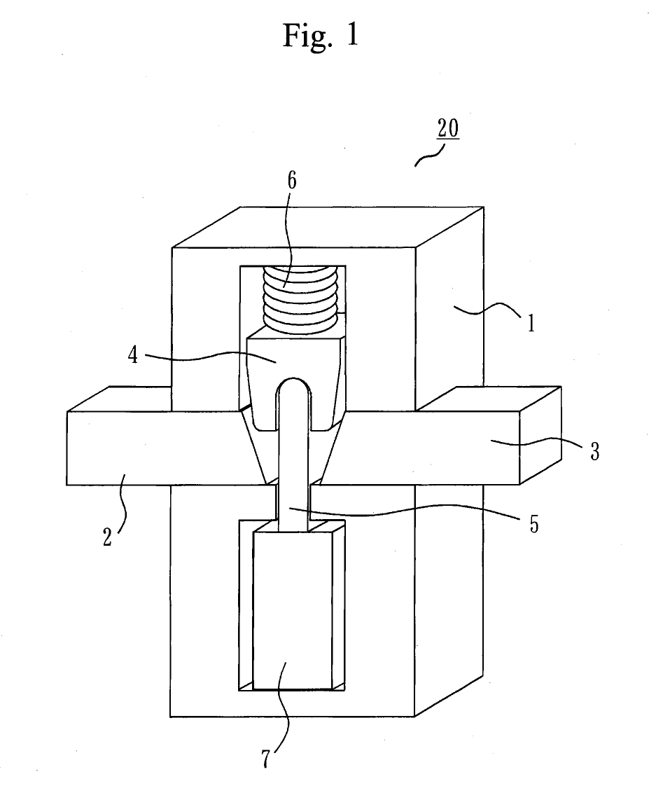

FIG. 1 is a schematic cross-sectional view of a bypass switch 20 according to a first embodiment.

As shown in FIG. 1, the bypass switch 20 according to the first embodiment is provided with a switch part and a case 1 constituted by an insulating material. The switch part includes a pair of conductors fixed to the case 1, namely, a first fixed conductor 2 and a second fixed conductor 3.

The first fixed conductor 2 and the second fixed conductor 3 are disposed being spaced from each other.

The switch part also includes a movable conductor 4.

The movable conductor 4 is disposed with a predetermined space from each of the first fixed conductor 2 and the second fixed conductor 3, in a vertical direction with respect to the first fixed conductor 2 and the second fixed conductor 3.

If a storage battery cell becomes a high resistance state or an open circuit state, or if the storage battery cell becomes a semi-failure state, the movable conductor 4 is displaced in the vertical direction with respect to the first fixed conductor 2 and the second fixed conductor 3, thereby being inserted between the first fixed conductor 2 and the second fixed conductor 3.

When the movable conductor 4 is inserted between the first fixed conductor 2 and the second fixed conductor 3, the first fixed conductor 2 and the second fixed conductor 3 are electrically connected by the movable conductor 4.

The bypass switch 20 is also provided with a pressure device 6 constituted by a coil spring or the like, which applies pressure to the movable conductor 4 and a shaft 5 in the vertical direction with respect to the fixed conductors 2 and 3.

When a thermally actuated device 7 is actuated, pressure applied by the pressure device 6 causes the shaft 5 to move downward. In conjunction with this, the movable conductor 4 comes into line contact with the first fixed conductor 2 and the second fixed conductor 3, thereby forming a bypass path.

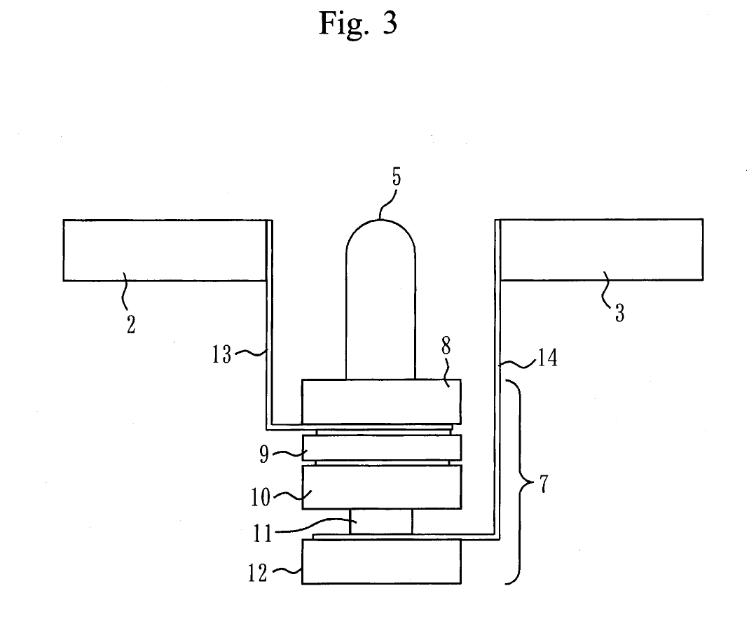

FIG. 3 shows an example of a configuration of the thermally actuated device 7.

In FIG. 3, the case 1, the movable conductor 4, and the pressure device 6 are not shown.

In FIG. 3, for simplicity of illustration, the shape of the first fixed conductor 2 and the second fixed conductor 3 is simplified.

In actuality, the first fixed conductor 2 and the second fixed conductor 3 are shaped as shown in FIG. 1.

As shown in FIG. 3, the thermally actuated device 7 is provided with a layered body in which solder 11 is sandwiched by a diode 9, a metal plate 10, a first heat-insulating spacer 8 and a second heat-insulating spacer 12.

That is, the single diode 9, the metal plate 10, and the solder 11 are stacked, and the diode 9, the metal plate 10, and the solder 11 are sandwiched between the first heat-insulating spacer 8 and the second heat-insulating spacer 12.

The diode 9 is a semiconductor device that generates heat when current flows through it.

When the storage battery cell is in a normal condition, the diode 9 is not energized. When storage battery cell malfunctions, the diode 9 is energized and generates heat by being energized.

The first heat-insulating spacer 8 reduces transfer of heat generated in the diode 9 to the outside of the thermally actuated device 7. The second heat-insulating spacer 12 reduces transfer of heat transferred to the solder 11 to the outside of the thermally actuated device 7.

The first heat-insulating spacer 8 is coupled with the movable conductor 4 through the shaft 5, and receives pressure applied by the pressure device 6 to the movable conductor 4.

The solder 11 is shaped to achieve low heat capacity and to reduce radiation coupling with the surrounding environment.

That is, the surface area of the solder 11 is smaller than the surface area of the metal plate 10.

The thermally actuated device 7 is also provided with a first connecting conductor 13 that electrically connects the first fixed conductor 2 and the diode 9, and a second connecting conductor 14 that electrically connects the solder 11 and the second fixed conductor 3.

The thermally actuated device 7 is thus configured to receive pressure from the pressure device 6 through the movable conductor 4 and the shaft 5 and to maintain electrical conduction.

In the present embodiment, flexible ribbon conductors are employed as the first connecting conductor 13 and the second connecting conductor 14.

Further, to provide a fuse function and a heat-insulating structure, metal having a high internal heat resistance is used as the first connecting conductor 13 and the second connecting conductor 14.

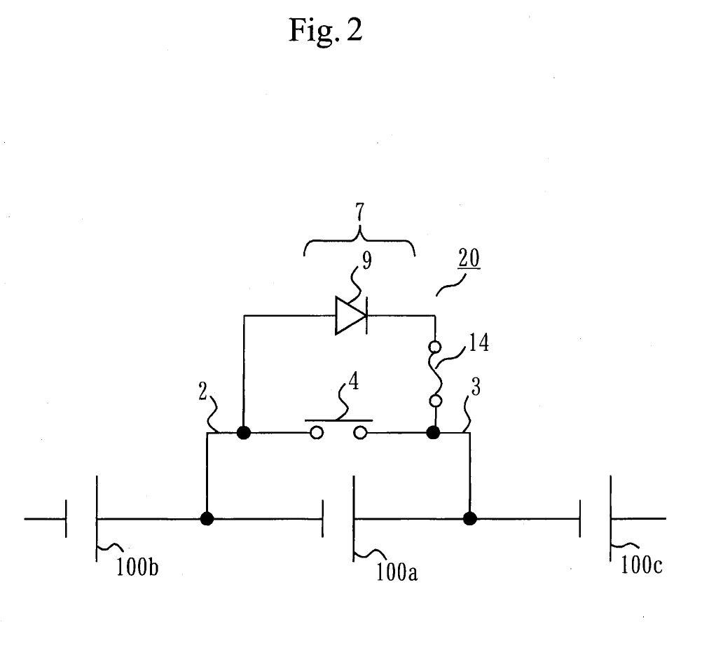

FIG. 2 is a circuit diagram in which the bypass switch 20 according to the present embodiment is connected in parallel with a storage battery cell.

Storage battery cells 100 are connected in series as shown in FIG. 2, and the bypass switch 20 is connected in parallel with each storage battery cell.

In FIG. 2, only the bypass switch 20 that is connected in parallel with a storage battery cell 100a is shown. Similarly, a bypass switch 20 is also connected in parallel with each of a storage battery cell 100b and a storage battery cell 100c.

As shown in FIG. 2, a parallel circuit constituted by the thermally actuated device 7 and the switch part (the first fixed conductor 2, the second fixed conductor 3, and the movable conductor 4) in the bypass switch 20 is connected in parallel with the storage battery cell 100a.

When the storage battery cell 100a is in a normal condition, the movable conductor 4 is not in contact with the first fixed conductor 2 and the second fixed conductor 3, as shown in FIG. 2.

Note that the second connecting conductor 14 has the fuse function.

In FIG. 2, the second connecting conductor 14 is represented as having the fuse function. However, the first connecting conductor 13 may have the fuse function, or both the first connecting conductor 13 and the second connecting conductor 14 may have the fuse function.

The operation of the bypass switch 20 according to the present embodiment will now be described.

According to the configuration of the circuit diagram shown in FIG. 2, when the storage battery cell 100a is in a normal condition, a reverse voltage is applied to the diode 9, so that no current flows through the diode 9 and the bypass switch 20 is not actuated.

However, when the storage battery cell 100a fails and becomes a high resistance state or an open circuit state, or when the storage battery cell 100a falls into a semi-failure state, that is, when the polarity of the cell is reversed in case of over discharge in the cell, forward current flows through the diode 9, causing the diode 9 to generate heat.

When the diode 9 generates heat, the heat is transferred to the solder 11 through the metal plate 10 within the thermally actuated device 7 and melts the solder 11.

Melting of the solder 11 causes the pressure device 6 to exert pressure, so that the thermally actuated device 7 moves downward and the shaft 5 coupled with the thermally actuated device 7 also moves downward.

As described above, by applying pressure to the movable conductor 4, the pressure device 6 forces the shaft 5 and the thermally actuated device 7 in a downward direction.

Displacement of the thermally actuated device 7 and the shaft 5 in the downward direction causes the movable conductor 4 to be displaced in the downward direction.

As a result, the movable conductor 4 comes into contact with the first fixed conductor 2 and the second fixed conductor 3, and the first fixed conductor 2 and the second fixed conductor 3 are electrically connected by the movable conductor 4, thereby forming a bypass circuit that short-circuits the malfunctioned storage battery cell 100a.

In case of over discharge in the storage battery cell 100, the polarity of the cell is reversed and the cell becomes a semi-failure state.

In the scheme disclosed in Patent Literature 1 in which a plurality of diodes are disposed in series, the voltage drop in the diodes is large and no current flows through the diodes, so that a bypass switch 20 is not actuated.

The bypass switch 20 according to the present embodiment is configured with the single diode 9, so that the voltage drop in the diode 9 is small and discharge current flows through the diode 9 when the polarity of the cell is reversed. Thus, the thermally actuated device 7 is actuated, and a bypass circuit is formed to short-circuit the malfunctioned storage battery cell 100.

The bypass switch 20 according to the present embodiment is configured with the single diode 9, so that the amount of heat generation by the diode 9 is smaller compared to the scheme disclosed in Patent Literature 1 in which a plurality of diodes are disposed.

In the present embodiment, the first heat-insulating spacer 8 is disposed between the diode 9 and the shaft 5, and the second heat-insulating spacer 12 is disposed between the solder 11 and the case 1.

The first heat-insulating spacer 8 and the second heat-insulating spacer 12 reduce transfer of heat generated by the diode 9 toward the shaft and the case, so that the heat generated by the diode 9 can be transferred to the solder 11 more efficiently compared to the arrangement disclosed in Patent Literature 1, thus providing the amount of heat necessary for bringing the solder 11 to a melting temperature.

While the solder 11 is being melted, the heat generated by the diode 9 decreases. By disposing the metal place 10 as a heat reservoir, the amount of heat necessary for melting the solder 11 can be supplied to the solder 11 even if the heat generated by the diode 9 decreases.

Further, the metal plate 10 is disposed below the diode 9 and the solder 11 is disposed below the metal plate 10. With this arrangement, the metal plate 10 can always be maintained at a higher temperature than the solder 11.

In the configuration where the single diode 9 is connected in parallel with the storage battery cell 100, a short-circuit fault in the diode 9 causes a short-circuit event in the storage battery cell 100 to which the diode 9 is connected in parallel, resulting in a failure in the cell.

In the present embodiment, the second connecting conductor 14 has the fuse function. When a short-circuit fault occurs in the diode 9, the second connecting conductor 14 is ruptured by short-circuit current, so that it is possible to prevent a short-circuit event in the cell due to the short-circuit fault in the diode 9.

Similarly, the first connecting conductor 13 may have the fuse function such that if a short-circuit fault occurs in the diode 9, the first connecting conductor 13 is ruptured by short-circuit current to prevent a short-circuit event in the cell due to the short-circuit fault in the diode 9.

The bypass switch according to the present embodiment can be effectively utilized as a small lightweight bypass switch in a satellite battery or the like.

As described above, according to the present embodiment, even if the storage battery cell becomes an over discharge state resulting in a semi-failure state, the bypass switch is actuated and discharge current can be diverted from the cell in the semi-failure state. When a short-circuit fault occurs in the diode, the fuse function in the bypass switch comes into action, and the failed bypass switch can be isolated from the storage battery cell.

The present embodiment has described a bypass switch that is connected in parallel with each of battery cells connected in series.

More specifically, it has been described that the bypass switch according to the present embodiment includes

fixed conductors constituted by a pair of fixed conductors,

a shaft that can be displaced in a vertical direction with respect to the pair of fixed conductors when the cell becomes a high resistance state or an open circuit state, or when the cell becomes a semi-failure state, and

a movable conductor disposed between the pair of fixed conductors with a predetermined space from and in a vertical direction with respect to the pair of fixed conductors, and configured to receive pressure in the vertical direction from a pressure device when the shaft is displaced, thereby being electrically connected with the fixed conductors and short-circuiting the cell.

It has been described that the bypass switch according to the present embodiment further includes

a thermally actuated device constituted by a layered body in which solder is sandwiched by a single semiconductor device that generates heat by a flow of current, a metal plate, and a pair of heat-insulating spacers, and

the thermally actuated device is provided with a connecting conductor that electrically connects the pair of fixed conductors, the semiconductor device, and the solder.

In the present embodiment, it has been described that the connecting conductor has a high heat-resistance material to construct a fuse function and a heat-insulating structure.

In the present embodiment, it has been described that the solder has a heat-insulating shape.

It has been described that heat generation of the semiconductor device decreases in the course of actuation, and thus the bypass switch according to the present embodiment is provided with the metal plate which serves as a heat reservoir to store heat and supply the heat to the solder, and that the metal plate is disposed below the semiconductor device and the solder is disposed below the metal plate so that the heat of the metal plate is effectively supplied to the solder.

### Reference Signs List

1: case, 2: first fixed conductor, 3: second fixed conductor, 4: movable conductor, 5: shaft, 6: pressure device, 7: thermally actuated device, 8: first heat-insulating spacer, 9: diode, 10: metal plate, 11: solder, 12: second heat-insulating spacer, 13: first connecting conductor, 14: second connecting conductor, 20: bypass switch, 100: storage battery cell

1. A bypass switch comprising:
a pair of fixed conductors disposed being spaced from each other and connected in parallel with a battery cell;
a movable conductor disposed in a vertical direction with respect to the pair of fixed conductors, and configured to be displaced in the vertical direction with respect to the pair of fixed conductors and inserted between the pair of fixed conductors;
a pressure device configured to apply pressure to the movable conductor in the vertical direction with respect to the pair of fixed conductors;
a thermally actuated device in which a single semiconductor device that generates heat by being energized, a metal plate, and solder are stacked and the semiconductor device, the metal plate, and the solder are sandwiched between a first heat-insulating spacer and a second heat-insulating spacer, the thermally actuated device being configured to be coupled with the movable conductor and receive the pressure applied to the movable conductor; and
a connecting conductor configured to connect the pair of fixed conductors with the semiconductor device, the metal plate, and the solder in parallel,
wherein the semiconductor device is configured not to be energized when the battery cell is in a normal condition, and to be energized and generate heat by being energized when the battery cell malfunctions, and the heat generated in the semiconductor device is transferred to the solder through the metal plate, causing the solder to melt, and melting of the solder causes the thermally actuated device to be displaced by the pressure applied by the pressure device, and displacement of the thermally actuated device causes the movable conductor to be displaced in the vertical direction with respect to the pair of fixed conductors and inserted between the pair of fixed conductors, and the pair of fixed conductors are thereby electrically connected to form a bypass circuit to short-circuit the battery cell that malfunctioned.

2. The bypass switch according to claim 1,
wherein the semiconductor device is configured to be energized before the battery cell becomes a high resistance state or an open circuit state.

3. The bypass switch according to claim 2,
wherein the semiconductor device is configured to be energized when a cell polarity of the battery cell is reversed.

4. The bypass switch according to claim 1,
wherein, in case of a short-circuit fault in the semiconductor device, the connecting conductor is configured to be ruptured by short-circuit current, so that the short-circuit current does not flow through the diode.

5. The bypass switch according to claim 1,
wherein the connecting conductor is constituted by a high heat-resistance material.

6. The bypass switch according to claim 1,
wherein the solder is shaped to reduce radiation coupling with a surrounding environment.

7. The bypass switch according to claim 6,
wherein a surface area of the solder is smaller than a surface area of the metal plate.

8. The bypass switch according to claim 1,
wherein the first heat-insulating spacer is configured to reduce transfer of the heat generated in the semiconductor device to an outside of the thermally actuated device, and the second heat-insulating spacer is configured to reduce transfer of the heat transferred to the solder to the outside of the thermally actuated device.

9. The bypass switch according to claim 1,
wherein the metal plate and the solder are disposed in contact with each other, and
the metal plate is configured as a heat reservoir to store the heat generated in the semiconductor device and supply the heat to the solder.
